(19) United States
(12) Patent Application Publication
(10) Pub. No.: US 2008/0019514 A1
(43) Pub. Date: Jan. 24, 2008

(54) METHOD FOR GENERATING A CRYPTOGRAPHIC KEY

(75) Inventors: Guido Stromberg, Munich (DE); Jan Dienstuhl, Munich (DE); Yvonne Gsottberger, Taufkirchen (DE); Werner Weber, Munich (DE); Ingolf Karls, Feldkirchen (DE); Daniel Bichler, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/669,354

(22) Filed: Jan. 31, 2007

(30) Foreign Application Priority Data
Jan. 31, 2006 (DE) 10 2006 004 399.5

(51) Int. Cl. H04L 9/00; G06F 7/58

(52) U.S. Cl. 380/46

(57) ABSTRACT

A method for generating at least one cryptographic key is provided in which several devices are each exposed to the same environmental conditions, the devices, taking into account the environmental conditions, each determine a value for a same physical quantity, and the devices each generate a cryptographic key by using the respective value of the physical quantity determined by the devices.

### CROSS-REFERENCE TO RELATED APPLICATION

This application claims priority to German Patent Application Serial No. 10 2006 004 399.5, which was filed Jan. 31, 2006, and is incorporated herein by reference in its entirety.

### TECHNICAL FIELD

The invention relates to a method for generating a cryptographic key.

### BACKGROUND OF THE INVENTION

To provide secure communication between devices, the messages are generally encrypted by means of cryptographic methods. The security is used, on the one hand, for protecting the messages against interception, protecting the messages against changes or for assuring the authenticity of the sender of a message. Efficient and secure methods for generating cryptographic keys are desired.

### BRIEF DESCRIPTION OF THE FIGURES

FIG. 1 shows a general flow chart for generating a cryptographic key and the structure of a corresponding encrypted communication according to an embodiment of the invention.

FIG. 2 illustratively shows the structure of secure communication between a mobile telephone and a Bluetooth head set according to another embodiment of the invention.

FIG. 3 shows selective steps from a method for generating a cryptographic key according to another embodiment of the invention.

FIG. 4 illustratively shows the communication in a wireless sensor network according to another embodiment of the invention.

### DESCRIPTION OF THE INVENTION

To provide secure communication between devices, the messages are generally encrypted by means of cryptographic methods. The security is used, on the one hand, for protecting the messages against interception, protecting the messages against changes or for assuring the authenticity of the sender of a message.

Exemplary embodiments of the invention can be mainly seen against the background of secure device control achieved by secure communication, wherein the controlling device and the controlled device exchange data via an interceptible connection such as, e.g. by radio.

A widely used method for encrypting data is the so-called symmetric encryption. In symmetric encryption, a shared secret key is used both for encrypting and for decrypting the data to be transmitted. One problem is that all participants in the communication need the same key in order to be able to encrypt the messages and to decrypt them again. In this case, the symmetric key must be transmitted between the devices between which a communication encrypted with the symmetric key is to take place. For this purpose, there are secure methods which, however, require very intensive computing such as, for example, the Diffie-Hellmann method.

The Diffie-Hellmann method allows a shared key to be generated for a pair of devices. The method is relatively secure but only enables a shared key to be generated for two communication participants and is also very computing-intensive. In addition, the method does not ensure that a communication based on the shared key generated, set up between the communication partners actually desired, is secure since all information for generating the key is public. For this reason, key certificates or similar methods would have to be accessed additionally.

There is a number of other methods normally used in practice in order to provide for a secure connection by means of symmetric encryption methods.

For example, for Bluetooth devices to be able to communicate with one another it is required, for example, that the user inputs the same code via an operating panel (e.g. keyboard or keypad) at every device. The device which wishes to establish the connection first generates a random number and sends this random and additionally its own Bluetooth device number to the other device. Using the code previously input, the random number and the Bluetooth device number, both devices generate the same symmetric key which is used for the further encryption of the data. It is a problem that the code must be input by the user. In addition, an operating panel is needed at the Bluetooth devices in order to input the code at all.

As an alternative, instead of inputting a code via an operating panel, a code permanently set in the device is used in the Bluetooth method described above (e.g. in head sets and computer mice) which clearly restricts the security of the data transmission.

In another concept, it is provided that a device determines a key by means of a random number generator and then transmits this key unencrypted to other devices. Each device which can intercept the key exchange of the key on which the encrypted communication is to be based knows the symmetric key by means of which the communication data transmitted between the devices are encrypted. It is thus not possible to prevent any unwanted monitoring of the communication between devices.

In addition, methods are used in which the keys used for the data exchange consist of two components, namely a public key part freely available in the network and a private, i.e. secret key part remaining on the device, in which no key exchange of a secret key is necessary. These methods are also called asymmetric encryption methods. In these methods, however, the encryption and decryption of the messages is very computing-intensive.

For this reason, the abovementioned methods are unsuitable for securely controlling devices when the devices are equipped with little computing power or if the least possible computing power is to be used for data transmission, e.g. for reasons of energy consumption.

According to an exemplary embodiment of the invention, a method for generating a cryptographic key is provided in which

a first device and a second device are in each case exposed to the same environmental conditions;

taking into account the environmental conditions, the first device and the second device in each case determine a value for the same physical quantity,

the first device generates a first cryptographic key by using the value determined by it for the physical quantity; and

the second device generates a second cryptographic key by using the value determined by it for the physical quantity.

A special feature in exemplary embodiments of the invention lies in how the key is generated. A security concept is provided which is based on the extraction of a cryptographic key from physical quantities in the environment of the devices involved in the communication to be secured.

For this purpose, the devices in each case are subjected to the same environmental conditions in the method so that it is made possible to generate a cryptographic key based on the same initial data (base data) in each case for each device independently of one another in that the initial data are in each case extracted from the environment of the devices.

Furthermore, in order to obtain the initial data from the environment, the devices in each case determine a value for the same physical quantity in that each device in each case carries out one or more measurements of this physical quantity.

A physical quantity is understood to be a measurable physical characteristic of a physical object or of a space or of an environment. Furthermore, the physical quantity which is used for the method should be suitably selected in such a manner that the environment of the devices can be sufficiently characterized or identified on the basis of measurements of this physical quantity.

The cryptographic keys generated by the devices are thus based on measurement data determined individually by the devices and are thus generated independently of one another.

In exemplary embodiments of the invention, the method can be extended to more than two devices.

An advantage of exemplary embodiments of the invention is that cryptographic keys matching one another can be generated in each case independently of one another by different devices.

In particular, in exemplary embodiments of the invention, no exchange of keys is required for carrying out a secure communication based on the use of cryptographic keys so that, for example, no unsecure key exchange or key exchange by means of computing-intensive methods is necessary.

In particular, the devices involved in the encrypted communication do not need to contact one another such as by radio contact, electrical contact etc. in order to in each case obtain the cryptographic keys matching one another for encrypted communication.

It is furthermore an advantage of exemplary embodiments of the invention that, apart from determining a value for the physical quantity, the devices do not need any further information inputs and therefore, in particular, no additional communication of the devices for exchanging keys is necessary in order to communicate with one another in a cryptographically secure manner on the basis of cryptographic keys matching one another. In particular, no operating steps are necessary such as, for example, the input of a key code on the devices and no additional operating elements, either.

A further advantage of an exemplary embodiment of the invention is that the range of validity of the communication between devices can be restricted to devices which are located within a certain environment. To achieve this, for example, the shared environment (security domain) of devices can be selected in such a manner, or the shared environment of the devices can be isolated in such a manner that outside this particularly selected or isolated environment, the same environmental conditions do not prevail and thus no matching cryptographic key can be extracted from the environmental conditions there.

Thus, the spatial vicinity of the devices to one another can be the criterion which determines whether the devices can set up a secure communication with one another or not. In many applications, this criterion matches the user's expectation since the conventional direct manual control of devices also presupposes the spatial vicinity of the person operating the device or of the controlling device to the controlled device.

Furthermore, a further advantage of an exemplary embodiment of the invention is that adding a new communication partner to an existing communication based on cryptographic keys generated by means of the method provided can be carried out in a simple manner by the new communication partner only being brought into the environment or into a “security domain” of the relevant communication. In this manner, a new communication partner or another device is subsequently also exposed to the same environmental conditions to which the devices of an existing communication are exposed or were exposed so that the new communication partner can also extract a corresponding cryptographic key from his environmental conditions or the environmental conditions prevailing in “security domain” and can thus enter into the communication.

In the further text, embodiments of the method will first be described wherein the embodiments described there can also be combined with one another as required and needed.

The cryptographic keys generated by the devices can be symmetric cryptographic keys, in other words a symmetric pair of keys. Furthermore, the devices can generate cryptographic keys, one of which is a public cryptographic key and another one of which is a private cryptographic key by means of which an asymmetric pair of keys is generated.

According to an embodiment of the invention, the devices are in each case exposed to the same environmental conditions in such a manner that they are in each case exposed to the same source. In this context, a source is understood to be a device or an object by means of which the environment of the devices can be influenced in a certain way, for example by an emission effect. Thus, the devices can in each case obtain the same measurement data by measuring the effect and an associated physical quantity or by measuring the emission of the source. The source can suitably send out as unambiguous a physical signature as possible, a random physical signature or a pseudo random physical signature.

The source can be a radiation source or a light source but other types of sources are also provided in alternative embodiments such as, for example, a broadcast transmitter, a sound source or an ultrasonic source or a noise source.

In this context, in particular, a sufficiently random noise source is suitable for extracting initial data for the generation of a cryptographic key by means of analysis of the noise profile. Furthermore, in the context of the method, for example, a (cryptographic) hash function, for example a secure hash function, can be used for analyzing a noise profile in order to generate a cryptographic key.

When a radiation source or a light source is used, a source of infrared light or visible light can be selected, in particular. For example, the devices can be brought into active contact or into visible contact with an infrared source which has a light emission in the infrared range which can be measured by the devices, which is sufficiently isotropic with regard to the extent of the environment within which the devices are located and which can be measured with sufficient accuracy with regard to the desired complexity of the key to be generated.

The source can be of such a nature that it sends out a time-coded pattern and/or frequency-coded pattern. In this context, in particular, a time-coded and/or frequency-coded infrared light source is particularly suitable for preparing the environmental devices in such a manner that initial data with sufficiently complex structure for generating cryptographic keys can be extracted by the devices from their environment. For this purpose, the source can be programmed by using a random generator or a pseudo random generator.

According to a further embodiment of the invention, the devices are in each case exposed to the same environmental conditions in such a manner that the devices are in each case brought into the same room or into the same building. According to this embodiment, the environmental conditions which are characteristic of this room or of this building are utilized for serving as a basis for extracting cryptographic keys from the environmental conditions.

In this embodiment of the invention, a “security domain” can be defined, in particular, by the respective boundaries of the room or of the building in which the devices are located between which communication is to take place.

This embodiment of the invention can be combined with the embodiment, described above, of using a source for influencing the environmental conditions of the devices.

Furthermore, this embodiment of the invention can be used, among other things, in a communication between the sensors of a wireless sensor network, for example during the performance of confidential measurements. Another possible use is given, for example, in communication between a host computer and a portable storage medium wherein, in particular, in the case of the additional use of a time-coded and/or frequency coded source, for example, a secure wireless communication can be comfortably set up, on the one hand, without requiring a key code to be input, or similar measures, and, on the other hand, particularly good blocking off of the “security domain” from the outside world can be ensured by suitably selecting the type of time-coded and/or frequency-coded source. Thus, for example, a comfortable wireless electronic data exchange is provided in a particularly simple manner for an archive, in which interception from outside the archive room is not possible during a key exchange.

Furthermore, according to another embodiment of the invention, the devices can in each case determine a value for an acoustic voice profile which is recorded, for example, by means of a microphone, as a value for the physical quantity. For example, a spoken sentence which is picked up by a microphone attached to the device is used for generating a key by this means.

According to this embodiment of the invention, the spoken sentence used can also be used for defining a correspondence of a “security domain”. In such a case, other devices can be admitted for participating in the communication in that the same sentence spoken into the first device is repeated with other devices.

Thus, in particular, this embodiment can also be set up in such a manner that a new communication partner can be added to the communication without problems namely by only reciting the same sentence by means of which the key of the other devices was generated, and a new device can thus generate the same key as the other devices.

As an alternative, a spoken random sentence can also be used.

Furthermore, this embodiment of the invention can also be combined with the embodiment of using a source. For this purpose, for example, a particular broadcast transmitter can be used for obtaining for the devices a spoken sentence which was emitted by the broadcast transmitter. In such a case, a particular external trigger can be used for obtaining a suitable starting time for recording a spoken sentence in order to define the spoken random sentence accurately for all devices involved in the communication. Furthermore, the use of an external trigger for obtaining a starting time for recording a spoken sentence can be combined with an internal trigger within the flow of language obtained from a broadcast transmitter in order to thus define the starting time more precisely. For example, the internal trigger can be a short pause or a particular tone within the flow of language of the broadcast transmitter and the external trigger can be a joint shaking or vibration of the devices.

This embodiment of the invention is particularly suitable for generating a cryptographic key for a communication between portable devices such as a Bluetooth headset and Bluetooth mobile radio telephone which are jointly carried or transported by a user, generally between devices which communicate with one another by means of a radio communication link.

As an alternative, the shaking of the devices or, more generally, an acceleration of the devices, can also be used for generating additional initial data for calculating a cryptographic key instead of generating only one external trigger for the starting time of a recording of a voice profile.

The shaking for generating an external trigger can be carried out, for example, by the user taking the devices together in one hand and shaking them jointly.

According to another embodiment of the invention, an acceleration is exclusively used for obtaining the initial data for generating a cryptographic key. In such a case, the use of an external random source can be omitted.

To obtain a cryptographic key, for example, a cryptographic key for the encrypted communication between a Bluetooth headset and a Bluetooth mobile radio telephone in which the encrypted communication can be set up without inputting a key code or without additional operating elements, from acceleration data, the acceleration is recorded by means of acceleration sensors and then evaluated in a suitable manner by the devices involved, each of the devices having at least one acceleration sensor.

In this embodiment of the invention, the physical quantity, in the present case the acceleration of the devices, can be recorded over a short or over a longer period depending on the requirements for complexity and quantity of the initial data for generating the cryptographic key. For example, the devices can be subjected to accelerations by being exposed to short and/or intense accelerations changing several times, i.e. illustratively shaking, or also by swinging them, for example, once or several times. The acceleration does not need to be carried out by the user directly but can also take place indirectly, for example by the user carrying the devices in a pocket or in a vehicle, for example relating to a mobile telephone and a hands free system for a mobile telephone.

The devices can be equipped in each case with firmware which continuously or at least repeatedly calculates cryptographic keys resulting from various types of accelerations so that the cryptographic keys used can be continuously or repeatedly renewed or made more complex during an existing communication if new initial data are continuously or repeatedly provided by acceleration.

The evaluating algorithm for the acceleration data which are jointly supplied to the devices involved in the communication is suitably selected in accordance with the requirements for the key generation and the type of environmental acceleration conditions recognized by the devices in each case, for example by the firmware installed in the devices. Thus, for example, in the case where the firmware of the devices recognizes a shaking-type acceleration environment, the acceleration vector detected in each case can be projected onto the direction of acceleration due to gravity in order to eliminate by this means any possibly disturbing rotational component of the respective accelerations caused by the shaking movements. On the other hand, the devices can filter out short jerky acceleration components for example for the case where the devices recognize an environment of swinging uniform accelerations that occur, among others during a trip with a vehicle.

In the analysis of the acceleration for generating a cryptograph key, for example, absolute amounts of accelerations, amounts of accelerations projected onto a particular direction, time intervals between changes in the acceleration or other suitable features which are specific of the type of a particular acceleration environment are used depending on requirements.

The acceleration for determining an acceleration patterns is recorded by means of suitable sensors such as, for example, ball switches or accelerometers.

Apart from the embodiments represented above, the devices can additionally use other types of physical quantities, for example in order to perform plausibility checks or to increase the security in that the environment in which the devices are located is detected even better by the devices. These additional measurements can be, for example, measurements of temperature, air humidity etc. and can be performed by the devices involved simultaneously, before or after the steps for determining in each case a value for the same physical quantity, described above.

As an alternative or additionally, the devices can also perform cross checks by looking at other aspects of physical quantities already used. For example if the evaluation of a voice profile is used for generating a cryptographic key, the absolute pitch or correlation of the voice of the user can be used for providing additional initial data for generating a cryptographic key or for allowing the generation of a cryptographic key.

Exemplary embodiments of the invention are shown in the figures and will be explained in greater detail in the further text.

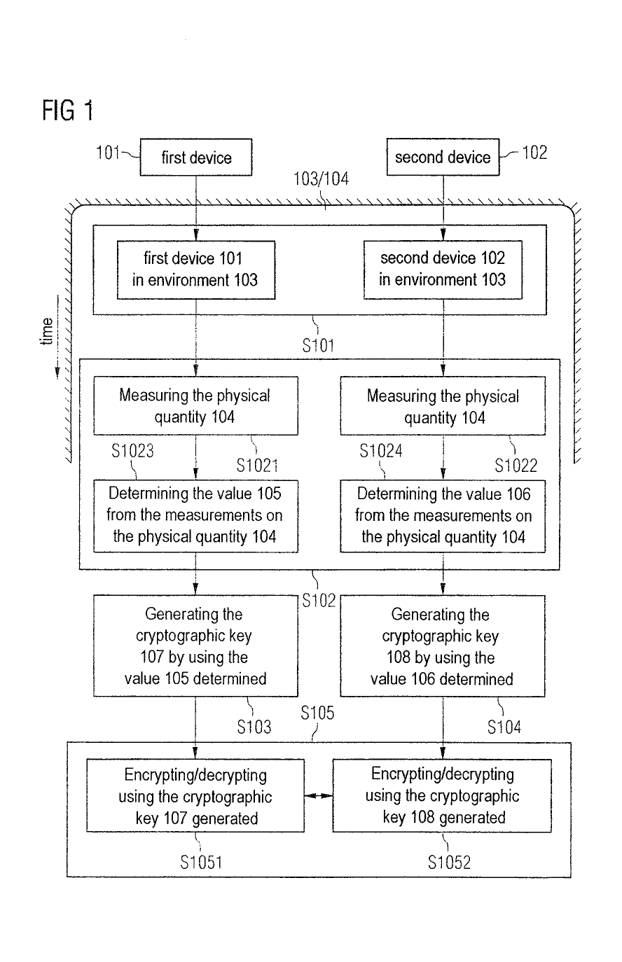

In the text which follows, the general sequence for generating a cryptographic key and the setting up of a corresponding encrypted communication according to an exemplary embodiment of the method according to the invention is described by means of FIG. 1.

To be able to set up an encrypted communication between a first device 101 and a second device 102, the first device 101 and the second device 102 are brought into the environment 103 in step S101. The first device 101 and the second device 102 are thus exposed to the environmental conditions of the environment 103. In the environment 103, the physical quantity 104 is present and can be measured in each case by the devices. The physical quantity 104 can be, for example, the emission pattern of a source present in the environment 103.

In step 102, both the first device 101 and the second device 102 in each case determine a value for the same physical quantity. For this purpose, both the device 101, in step S1021, and the device 102, in step S1022, initially perform measurements of the physical quantity 104 in the environment 103.

According to this exemplary embodiment, the first device 101 and the second device 102 do not need to be brought into the environment 103 simultaneously as is shown in FIG. 1. Instead, for example, first device 101 can be brought into the environment 103 so that initially the first device 101 performs measurements on the physical quantity 104 whereupon the second device 102 is then brought into the environment 103 and also performs measurements of the physical quantity 104 whilst the first device 101 either remains in the environment 103 or is brought out of it again.

In step S1023, the first device 101 then determines a first value 105 from the raw data of the measurements of the first device 101 on the physical quantity 104 in the environment 103. Furthermore, the second device 102 determines a second value 106 from its measurements on the physical quantity 104 in the environment 103 in step S1024.

In step S103, the first device 101 then generates a cryptographic key 107 by means of the value 105 determined from the measurements on the physical quantity 104 whereas the second device 102 generates a cryptographic key 108 from the value 106 determined by it in step S104.

Since the cryptographic key 107 generated by the first device 101 results for measurements of the physical quantity 104 in the environment 103, and the cryptographic key 108 generated by the second device 102 also results for measurements of the same physical quantity 104 in the environment 103, the two cryptographic keys are based on the same initial data, namely the measurement data of the physical quantity 104 in the environment 103. In particular, the values 105 and 106 determined can be identical.

The cryptographic keys 107 and 108 thus match one another and are therefore suitable to be used as a basis for an encrypted communication between the devices 101 and 102. In step S105, an encrypted communication then takes place between the devices 101 and 102 by using the cryptographic keys 107 and 108 generated. As is shown in part-steps S1051 and S1052 of step S105 in FIG. 1, the first device 101 can encrypt and decrypt the messages by using the key 107 generated by it, whereas the second device 102 encrypts and decrypts the messages by using the key 108 generated by it.

The exemplary embodiment shown in FIG. 1 can be used, for example, for setting up a secure personal area network (PAN) for securely controlling devices or for the secure data exchange of devices. Thus, the first device 101 can be, for example, a mobile telephone and the second device 102 can be, for example, a Bluetooth headset.

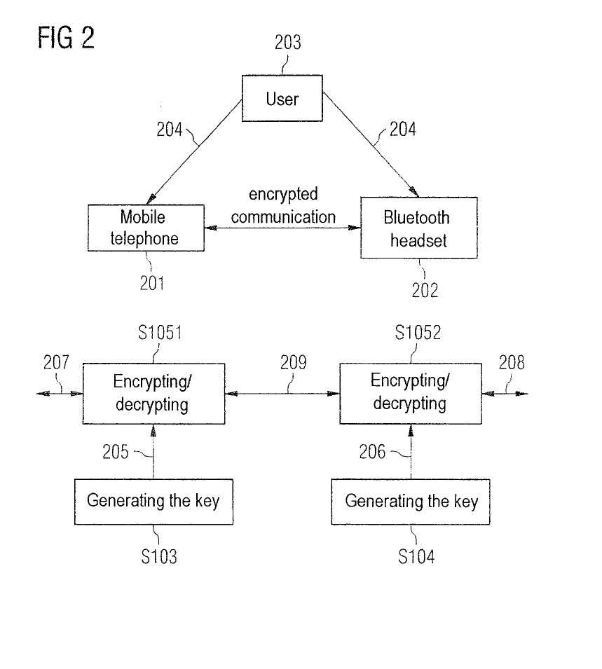

FIG. 2 illustratively shows the setting up of a secure communication between a mobile telephone 201 and a Bluetooth headset 202 according to another exemplary embodiment of the invention. This communication comprises both the transmission of control data (e.g. volume control, push-to-talk) and the transmission of bidirectional voice data. This exemplary embodiment represents the special case where inputting a code into at least one of the participating devices, in the present case relating to the headset 202, is impossible due to lacking operating elements whereas the application requires a secure connection.

As shown in FIG. 2, a user 203 of the mobile telephone 201 and of the Bluetooth headset 202 speaks a particular sentence 204 at the beginning of the communication in the exemplary embodiment and this sentence is recorded both by the mobile telephone 201 and the Bluetooth headset 202.

According to the exemplary embodiment, a cryptographic key 205 and 206, respectively, is in each case generated from the voice profile of the spoken sentence 204 by means of a suitable hash function in the devices involved, which key is in each case used subsequently as key for encrypting the data communication between the mobile telephone 201 and the Bluetooth headset 202. For this purpose, the mobile telephone 201 initially generates in step S103 the cryptographic key 205 from the voice profile of the sentence 204 and the Bluetooth headset 202 generates in step S104 the cryptographic key 206 of the voice profile of the sentence 204.

As can also be seen from FIG. 2, unencrypted data 207 and 208 are received and/or transmitted both by the mobile telephone 201 and by the Bluetooth headset 202 such as, for example, the call data or the sound which is output by the loudspeaker of the headset 202 in the case of the Bluetooth headset 202. Via this means, the unencrypted data 207 and 208, respectively, received/transmitted by the mobile telephone 201 and the Bluetooth headset 202 are exchanged between the mobile telephone 201 and the Bluetooth headset 202 in the form of encrypted data 209.

To achieve this, the mobile telephone 201 and the Bluetooth headset 202 use in step S1051 and in step S1052, respectively, the cryptographic keys 205 and 206, respectively, which were generated independently of one another in the participating devices, that is to say in the mobile telephone 201 and the Bluetooth headset 202 in steps S103 and S104, respectively, for carrying out the decryption/encryption of the data 209 as part of the encrypted communication. According to the method, a secure, i.e. encrypted communication is thus set up.

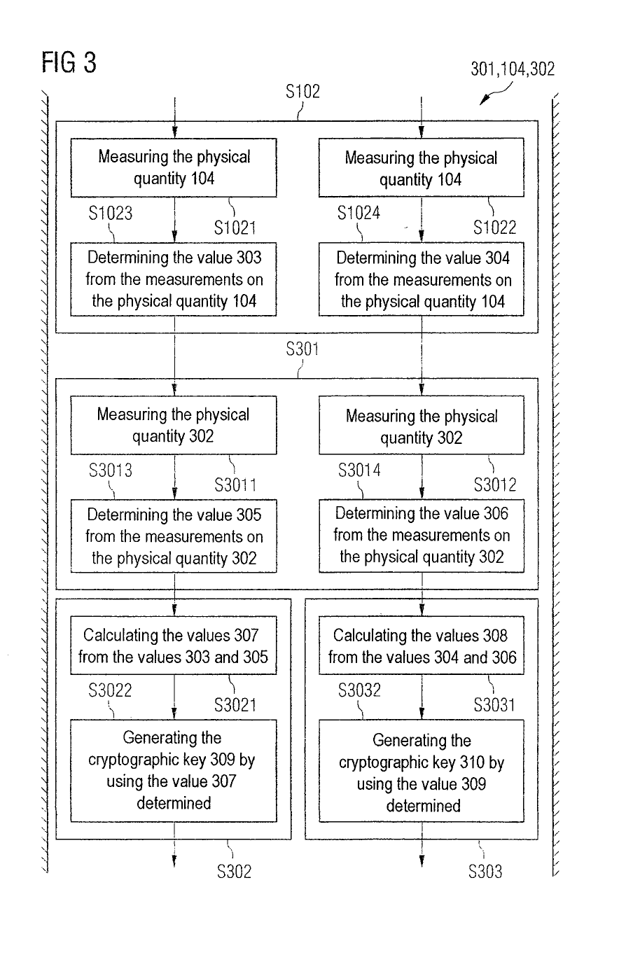

FIG. 3 shows selective steps from a method for generating a cryptographic key according to yet another embodiment of the invention. The method for generating a cryptographic key proceeds similarly to the exemplary embodiment shown in FIG. 1, the difference being that in this case two physical quantities are used for obtaining initial data for generating in each case one cryptographic key.

According to the exemplary embodiment of the invention shown in FIG. 3, the devices 101 and 102 determine, in addition to the determining of in each case one value for the physical quantity 104 already explained in conjunction with step S102 in FIG. 1, a value for the physical quantity 302 in each case in step S301. The physical quantity 302 can be a physical quantity of a different type or the same type as the physical quantity 104 and is used for additionally increasing the security of the method. Similarly to the physical quantity 104, the physical quantity 302 is suitably selected depending on the application.

As is shown in FIG. 3, according to the exemplary embodiment of the invention, a measurement of the physical quantity 302 is carried out in step S301, part-step S3011 by the first device 101 in order to determine from this measurement the value 305 in part-step S3013. Furthermore, the second device 102 analogously performs a measurement of the physical quantity 302, and determines the corresponding values 306, in part-steps S3012 and S3014.

In the exemplary embodiment of the invention shown in FIG. 2, the values determined for the physical quantity 302 from the environment 301 by the devices in step S301, i.e. the value 305 determined by the device 101 and the value 306 determined by the device 102 can be calculated in each case, for example by a multiplication, into the values 303 and 304 previously determined from the physical quantity 104 in order to obtain the final values 307 and 308, respectively. For this purpose, the first device 101 in step S302 first calculates the value 307 from the values 303 and 305 in part-step S3021 in order to then calculate or generate the cryptographic key 309 from the value 307 in part-step S3022. Analogously, the second device in step S303 first calculates the value 308 from the values 304 and 306 in part-step S3031 in order to then generate the cryptographic key 310 from these in part-step S3032.

In the exemplary embodiment shown in FIG. 3, therefore, the security of the method can be increased compared with the exemplary embodiment shown in FIG. 1 since, according to the third exemplary embodiment, the participating devices, in the present case the first device 101 and the second device 102 perform, instead of one measurement in each case, two measurements of a physical quantity in each case and, therefore, more initial data can be obtained for the key generation and thus more complex cryptographic keys can be generated.

For example, in the exemplary embodiment shown in FIG. 3 as in the exemplary embodiment shown in FIG. 1, the physical quantity 104 can be the emission pattern of a source located in the environment 301 of the devices 101 and 102, for example the emission pattern of an infrared source, and the physical quantity 302 can be, for example, an acoustic voice profile. As an alternative, the physical quantities 104 and 102 of the exemplary embodiment shown in FIG. 2 can also be other combinations of physical quantities. Thus, for example, an acoustic voice profile can also be used as physical quantity 104 and an acceleration pattern, for example, can be used as physical quantity 302.

In this way, data or values can be obtained from the environment 301 of the devices 101 and 102 repeatedly, in the present case twice, in accordance with the exemplary embodiment shown in FIG. 2 in order to be available as initial data for generating a cryptographic key. The exemplary embodiment of the invention shown in FIG. 2 can be extended so that an encrypted communication based on cryptographic keys which were generated by using the values 303 and 304 is already set up and carried out between steps S102 and S301. With such an extension of this exemplary embodiment of the method, an encrypted communication can also already take place when the physical quantity 302 is not available for a measurement immediately after the measurement of the physical quantity 104. This can be the case, if the physical quantity is an acoustic voice profile of a particular spoken sentence which is only spoken with a certain delay after the values 303 and 304 have been determined wherein, for example, configuration data or other data can already be exchanged encrypted between the devices 101 and 102 even before the particular sentence is spoken.

According to another aspect of the exemplary embodiment of the invention shown in FIG. 3, a value determined in step S301 from the physical quantity 302, in the present case therefore the value 305 determined by the first device 101 and/or the value 306 determined by the second device 102, can also be used as criterion or trigger for either admitting a communication encrypted with cryptographic keys which are based on initial data such as the values 303 and 304, or not. It can thus be provided, for example when the environment 301 is a particular archive room with a constant air humidity and/or temperature, that an encrypted communication according to the invention can only be set up when a particular (predetermined) air humidity and/or temperature prevails in the archive room. In this manner, additional protection against interception of the communication via devices outside the environment 301 can be provided, for example.

To achieve this, a nominal value for the desired air humidity and/or temperature, for instance, can be preset in one of the devices, for example in device 101. For this reason, the measurement of the physical quantity 302, that is to say the air humidity and/or the room temperature of an archive room, is replaced in step S301, part-step S3011 for determining the value 305, by the corresponding preset value or nominal value being read out internally within the device 101. In contrast, device 102 performs in part-step S3012 a measurement of the air humidity and/or temperature 302 of the archive room. The values 305 and 306 can now be combined with the value 303 or with the value 304, respectively, to form 307 or to form 308, respectively, as shown in step S302 and in step S303, respectively, in order to then generate the cryptographic keys 309 and 310. The keys 309 and 310 generated will therefore match only in the case where the air humidity and/or temperature measured by the device 102 in the environment 301 corresponds to the nominal value stored in the device 101. An implicit comparison of the temperature/air humidity measured by the second device 102 with the predetermined nominal value stored in the device 101, together with a positive or negative decision based on this comparison whether the encrypted communication should be allowed or not, is thus relatively achieved.

This procedure can also be considered as a type of double encryption in which the encrypted communication to be carried out is carried out by using cryptographic keys which are based on the physical quantity 104 or, respectively, on values determined for it, but setting up the encrypted communication based on these cryptographic keys is only allowed when the cryptographic keys based on the physical quantity 302 additionally match one another.

If in each case a portable device, particularly a device carried by a user, is used as first device 101 and as second device 102, an acceleration or acceleration pattern can be suitably selected as physical quantity 302 for the method of the exemplary embodiment shown in FIG. 2. In this context, the values 305 and 306 determined for the physical quantity 302 by the devices 101 and 102 in step S301 can be used either as an “admission key” according to the double encryption described above, or the values 305 and 306 are calculated into or combined with the final values 307 and 308 used for generating the cryptographic key 309 and 310 to be generated, as is also described above.

As already mentioned above, the physical quantities 104 and 302 can also be of the same type. Thus, the physical quantities 104 and 302 can both be, for example, an acceleration.

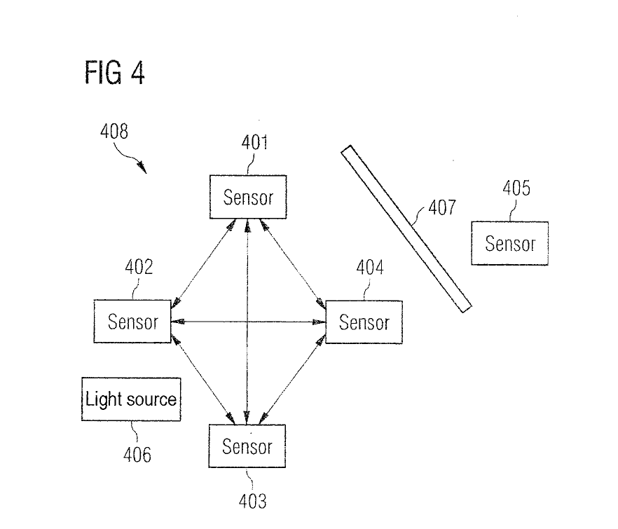

According to an exemplary embodiment of the invention shown in FIG. 4, an acceleration is in each case selected for the physical quantities 104 and 302 wherein, according to this exemplary embodiment, compared with the exemplary embodiment shown in FIG. 3, in addition to the steps of determining values from in each case the same physical quantity, already performed in accordance with the exemplary embodiment shown in FIG. 3, several more such determining steps are carried out. For this purpose, according to the exemplary embodiment of the invention shown in FIG. 4, each device involved in each case determines a value from an acceleration pattern after the steps for generating in each case one cryptographic key, that is to say after the steps S302 and S303 shown in FIG. 3. Following this, the additional values determined are used for each of the devices involved in the encrypted communication for in each case generating a more complex cryptographic key compared with the cryptographic keys 309 and 310 already generated in steps S302 and S303 by adding the values generated in the additional determining steps as additional initial data to the initial data already present or collected in the devices in order to then generate by means of this in each case a new (updated) cryptographic key.

Furthermore, according to the exemplary embodiment of the invention shown in FIG. 4, the steps of generating updated cryptographic keys are repeated at particular time intervals. For this purpose, the lengths and the starting times of the time intervals in which in each case measurements of the physical quantity, in the present case of the acceleration, are carried out by the devices involved are adjusted to one another by signal exchange between the devices involved.

According to the exemplary embodiment of the invention shown in FIG. 4, the cryptographic keys of a set of updated cryptographic keys thus replace the keys of the preceding set of cryptographic keys in the encrypted communicated between the devices involved.

FIG. 4 illustratively shows the communication within a WLAN (wireless local area network) according to the exemplary embodiment of the invention shown in FIG. 4. The WLAN can be, for example, a wireless sensor network. The exemplary embodiment of the invention shown in FIG. 4 represents a special case in which a security domain is set up for the encrypted communication between the devices involved. To be able to set up the encrypted communication according to the method, only the sensors 401 to 404 are initially exposed jointly to a light source 406 for a particular period, for example for a few seconds, the sensor 405 being separated from the light source 406 by a wall 407, however. While they are exposed to the light source 406 and/or after they were exposed to the light source 406, the sensors 401 to 404 in each case locally generate the same cryptographic key by means of which the following communication is then encrypted, which sets up a security domain 408. All devices within this domain 408, i.e. only the sensors 401 to 404, can communicate with one another. Sensor 405, however, is separated from the light source 406 by a wall 407 and thus excluded from the security domain 408 and, therefore, does not have the same key as the sensors 401 and 404 and can thus not participate in the communication with the other sensors.

What is claimed is:

1. A method for generating at least one cryptographic key, comprising:
exposing a first device and a second device to the same environmental conditions;
determining, taking into account the environmental conditions, a random or pseudo-random value for a same physical quantity by each of the first device and the second device;
generating a first cryptographic key by the first device by using the random or pseudo-random value of the physical quantity determined by the first device as a base value for generating the first cryptographic key; and
generating a second cryptographic key by the second device by using the random or pseudo-random value of the physical quantity determined by the second device as a base value for generating the second cryptographic key.

2. The method as claimed in claim 1, further comprising determining, taking into account the environmental conditions, a value for another physical quantity by at least one of the first device and the second device.

3. The method as claimed in claim 2, further comprising determining, based on the value of the other physical quantity, whether to admit a communication encrypted with the first and/or second cryptographic keys.

4. The method as claimed in claim 1, further comprising carrying out encrypted communication using the first and second cryptographic keys only when the first and second cryptographic keys match one another.

5. The method as claimed in claim 1, wherein the first device and the second device are each exposed to the same environmental conditions such that the first device and the second device are each exposed to a same source.

6. The method as claimed in claim 5, wherein the source is a radiation source or a light source.

7. The method as claimed in claim 6 wherein the source is a source emitting infrared light or visible light.

8. The method as claimed in claim 5, further comprising determining a time-coded pattern and/or of a frequency-coded pattern from the source by each of the first device and the second device.

9. The method as claimed in claim 1, wherein the first device and a second device are each exposed to the same environmental conditions such that the first device and a second device are each brought into a same room or into a same building.

10. The method as claimed in claim 1, wherein the first device and the second device are each exposed to the same environmental conditions such that the first device and the second device are each exposed to a same acceleration.

11. The method as claimed in claim 10, wherein the first device and the second device each determine a value of a same physical commodity such that the first device and the second device determine several acceleration values so that the first device and the second device each determine an acceleration pattern to which the first device and the second device are jointly subjected.

12. The method as claimed in claim 11, wherein the first device and the second device each use accelerometers or ball switches to determine the acceleration pattern.

13. The method as claimed in claim 1, wherein the first device and the second device each determine a value for an acoustic voice profile as a value for the same physical quantity.

14. The method as claimed in claim 1, wherein the first device and the second device each determine a value for a noise profile of environmental noises as a value for the same physical quantity.

15. The method as claimed in claim 1, wherein at least one of the first device and the second device uses a hash function for generating the first and second cryptographic key, respectively.

16. The method as claimed in claim 1, wherein the first cryptographic key generated and the second cryptographic key generated are each symmetric cryptographic keys.

17. The method as claimed in claim 1, wherein, of the first cryptographic key generated and the second cryptographic key generated, one is a public cryptographic key and the other is a private cryptographic key belonging to the public cryptographic key.

18. The method as claimed in claim 1, wherein the first device is a mobile telephone, and the second device is a Bluetooth headset.

19. A method for generating at least one cryptographic key, comprising:
exposing a first device and a second device to the same environmental conditions;
determining, taking into account the environmental conditions, a first random or pseudo-random value for a first same physical quantity by each of the first device and the second device;
determining, taking into account the environmental conditions, a second random or pseudo-random value for a second same physical quantity by each of the first device and the second device;
calculating a first total random or pseudo-random value for the first device based on the first random or pseudo-random value, and calculating a second total random or pseudo-random value of the second device based on the second random or pseudo-random value;
generating a first cryptographic key by the first device by using the first total random or pseudo-random value of the physical quantities determined by the first device as a base value for generating the first cryptographic key; and
generating a second cryptographic key by the second device by using the second total random or pseudo-random value of the physical quantities determined by the second device as a base value for generating the second cryptographic key.

20. A system for generating at least one cryptographic key, comprising:
an exposing means for exposing a first device and a second device to the same environmental conditions;
a determining means for determining, taking into account the environmental conditions, a random or pseudo-random value for a same physical quantity by each of the first device and by the second device;
a first generating means for generating a first cryptographic key by the first device by using the random or pseudo-random value of the physical quantity determined by the first device as a base value for generating the first cryptographic key; and
a second generating means for generating a second cryptographic key by the second device by using the random or pseudo-random value of the physical quantity determined by the second device as a base value for generating the second cryptographic key.
